(19) United States
(12) Patent Application Publication
(10) Pub. No.: US 2025/0092961 A1
(43) Pub. Date: Mar. 20, 2025

(54) CENTRALIZED CONTROL VALVE

(71) Applicant: HouJie SUN, SR., HuiZhou (CN)

(72) Inventor: HouJie SUN, SR., HuiZhou (CN)

(21) Appl. No.: 18/810,498

(22) Filed: Aug. 20, 2024

(30) Foreign Application Priority Data
Sep. 20, 2023 (CN) 2023112146766
May 13, 2024 (CN) 2024210245466

(51) Int. Cl. F16K 31/528

(52) U.S. Cl. CPC F16K 31/528

(57) ABSTRACT

A centralized control valve, its operations of selection of entering of multiple supply waters including thermal water and cold water and of switch or regulation of water flow all are integrated into a press-knob button, a centralized control button, to rotate the button to select the entering of multiple supply waters, to press the button repeatedly or temperately to switch or regulate water flow.

One or more of various valve control devices in the background technologies are coupled with a ceramic valve core via mechanical hinge, therein the vertical motion of pressing or lifting the button is converted to deflexion motion of the handle of said valve core rounding itself horizontal axis, and the torque of rotating the button is transported to the handle of the valve core to select entering of multiple supply waters.

### FIELD OF THE PRESENT INVENTION

The present invention relates to a water valve, particular to a centralized control valve, which is equipped with one press-knob button rather than more buttons or a combined like one, through a mechanical hinge, said centralized control valve can realize the selection of multiple water intakes and the switch or regulation of a supply water flow. By a large-angle oblique thread pair, equipped with a single ceramic valve core, when pressing repeatedly or moderately to a top button, a single water supply valve will switch or regulate supply water flow.

The centralized control valve can be used for the switch or regulation of other liquids, the various mechanical structures described in this device can be applied to other civil equipment, furthermore, applied to industrial equipment, municipal establishment and equipment, military weapon and equipment, such as industrial valve, weapon fire control system, shot loading system, drive system etc.

### BACKGROUND OF THE PRESENT INVENTION

This invention is referred to patents ZL2022100822570, ZL2015101571809ZL202010021227X and prior arts, utilizing various valve control devices of said patents, and/or single water ceramic valve core for single water inlet, and/or thermal and cold water ceramic valve core for multiple water inlet, through mechanical valve hinge, large angle oblique thread pair, etc., realizes the switch and/or regulation of supply water flow, and the selection of multiple water entering, all the operations said above are integrated on a press-knob button, which extremely facilitates the operations of water valve with pleasure.

said valve control devices are configured by various valve control systems to locate opened or closed position of a shaft of water valve, furthermore, including any position of said shaft, please consult said patents above for detailed information.

Said ceramic valve core above is widely mounted within almost all civil water valves, which is a combination of a pair of superposed ceramic valve disc and ceramic valve seat for switch with highly smooth contacted surface, when said ceramic valve disc shut a groove on the ceramic valve seat the water flow will be shut, otherwise will be circulated, when there are multiple grooves on ceramic valve seat, multiple supply waters can be selected by rotating the ceramic valve disc.

Now, all industrial and civil water valves are mounted with a valve handle to switch and/or select one supply water from multiple supply waters, some manufacturer maybe mount a press button to open a supply water by pressing then shut automatically but not by hand, or contrarily operation, some types of knob buttons may be mounted to switch a supply water by manually rotating but cannot select multiple supply waters, thereout, some water valve operation buttons must actually be mounted more than one button though looks like one to complete all operations of switch and selection for supply waters. To sum up above, those technology features of the operation of ordinary skill may be not facility and may give an opportunity to run and leak for water at a certain significance.

The present invention integrates all the operations of the water valve into one press-knob button, a centralized control button, provides an excellent solution for the integration of water valve operation conveniently with saving water without consciousness.

### SUMMARY OF THE PRESENT INVENTION

This invention is to provide a device of water valve to control water flow, its significance lies in all control operations of the water valve are centralized into a press-knob button, a centralized control button, its technical characteristics are introduced below briefly:
at least two eccentric hinge pieces 22 are mounted at lower end of a valve shaft/stem 11 which are tightened under a press-knob button 14 as a whole;
said hinge pieces 22 are clamped outside of a valve core handle 12 which must be ensured that relative motion of the valve stem 11 driving the valve core handle 12 is flexible;
a hinge rod 23 is tightened to the lower part of said hinge pieces 22 and embedded in a penetrated hinge groove 21 with mouth opened right upwards on upper part of valve core handle 12 which must be ensured their relative motion of said hinge rod 23 driving said valve core handle 12 is flexible;
a valve hinge comprises the hinge rod 23, the hinge groove 21 and the hinge pieces 22 to drive the ceramic valve core 13;
when pressing the button 14 namely the valve shaft 11, the hinge rod 23 will drive the hinge groove 21 to force the valve core handle 12 to rotate clockwise around its horizontal axis 15 and finally to dock at opened position of ceramic valve core 13; otherwise
when the button moving upwards, the valve core handle 12 will be rotated counterclockwise around its horizontal axis 15 and finally be docked at closed position of the ceramic valve core 13; furthermore
by controlling the valve stem 11 to locate at any position including opened or closed position of its whole vertical journey, the hinge rod 23 will force the valve core handle 12 to locate at a corresponding position to perform the function of water flow regulation; simultaneously
when the valve stem 11 is located at any position said above, through the valve stem 11 and the hinge pieces 22, a horizontal rotation of the press-knob button 14 will rotate the valve core handle 12 to perform the function of selecting multiple water inlets.
wherein the valve hinge mechanism to drive the ceramic valve core 13 configured with the hinge rod 23 and the hinge groove 21 can be replaced by following mechanism:
the lower end of the valve stem 11 is tightened with a wedge 61 which inclined surface opposites to the upper left angle of the valve core handle 12, also tightened with a recovery rod 62 located under lower right of a curved surface of upper right part of the valve core handle 12, wherein, said inclined surface and curved surface are parallel to the axis of said recovery rod 62;
when the valve stem 11 moves vertically downwards, the inclined surface of the wedge 61 will drive the valve core handle 12 to rotate clockwise through said angle, and when the valve stem 11 moves vertically upwards, the recovery rod 62 will force the valve core handle 12 to rotate counterclockwise through said curved surface then return to its initial closed position.
only one press-knob button 14 is mounted on top of water valve, to rotate said button to select an entering of multiple supply waters, and to press said button repeatedly or moderately to switch or regulate a water flow.
a large angle oblique external thread accessory 33 is tightened at the upper end of the single valve core handle 32 for only one entering of supply water; and
a large angle oblique internal thread accessory 34 is tightened at the lower end of a valve stem 11; so said two large angle oblique thread accessories meshed each other configure a large angle oblique thread pair;
wherein by pressing or lifting the button 14, the vertically moving valve stem 11 will rotate the single valve core handle 32 to turn leftwards or rightwards via the large angle oblique thread pair to switch or regulate single supply water flow.
wherein the large angle oblique thread pair can be replaced by a parallel shaft worm gear pair 41 to realize the conversion from vertical movement to horizontal rotation movement; or
be replaced by an inclined groove fork 51 tightened at the lower end of a valve stem 11 to drive a lever 52 tightened at the upper end of the single valve core handle 32 which configure an inclined fork lever hinge via an inclined groove 53 to realize said same conversion.

### BRIEF DESCRIPTION OF THE DRAWINGS

This invention is described in more detail below on the basis of the theories with reference to the accompanied drawings.

In the drawings,

FIG. 1 assembly sketch of the mechanical hinge of the centralized control valve for multiple supply water, closed position;

FIG. 2 assembly sketch of the mechanical hinge of the centralized control valve for multiple supply water, opened position;

FIG. 3 assembly sketch of the Mechanical hinge of the large angle oblique thread pair of single inlet water valve;

FIG. 4 assembly sketch of the Mechanical hinge of the parallel shaft worm gear pair of single inlet water valve;

FIG. 5 assembly sketch of the Mechanical hinge of the inclined groove fork and lever of single inlet water valve;

FIG. 6 assembly sketch of the mechanical hinge of the centralized control valve for multiple supply water, second implemented case;

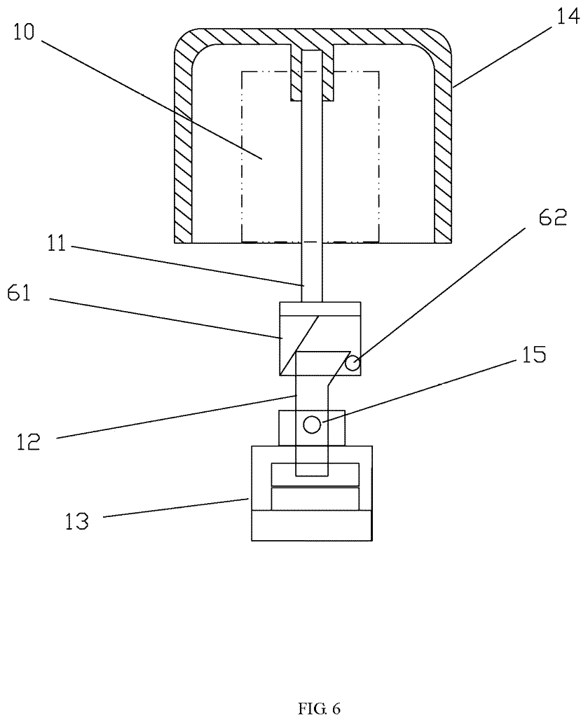

### DESCRIPTION OF THE PREFERRED EMBODIMENTS

Herein give a detailed description for the present invention assisted with attached figures as follows.

In this invention, the centralized control valve, the valve control device 10 adopts various possible valve control devices in the background patent technology to locate the vertical position of a valve shaft then to switch or regulate a supply water.

Two eccentric hinge pieces 22 are tightened at lower end of a valve shaft/stem 11 which is tightened under a centralized control button 14 as a whole; said hinge pieces 22 are just clamped outside of front and rear of a ceramic valve core handle 12 which must be ensured that relative motion of the valve stem 11 driving the valve core handle 12 is flexible; A hinge rod 23 is tightened to the lower part of said hinge pieces 22 and embedded in a penetrated hinge groove 21 with mouth opened right upwards on upper part of valve core handle 12 which must be ensured their relative motion of said hinge rod 23 driving said valve core handle 12 is flexible;

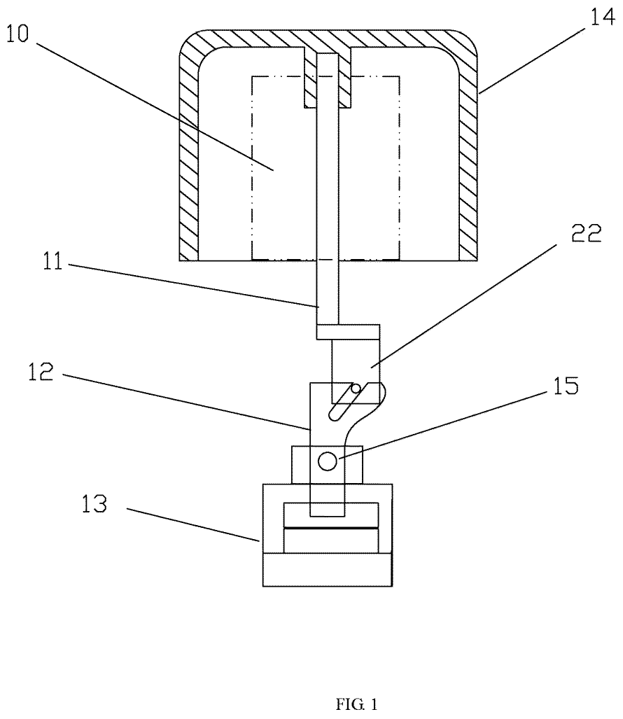

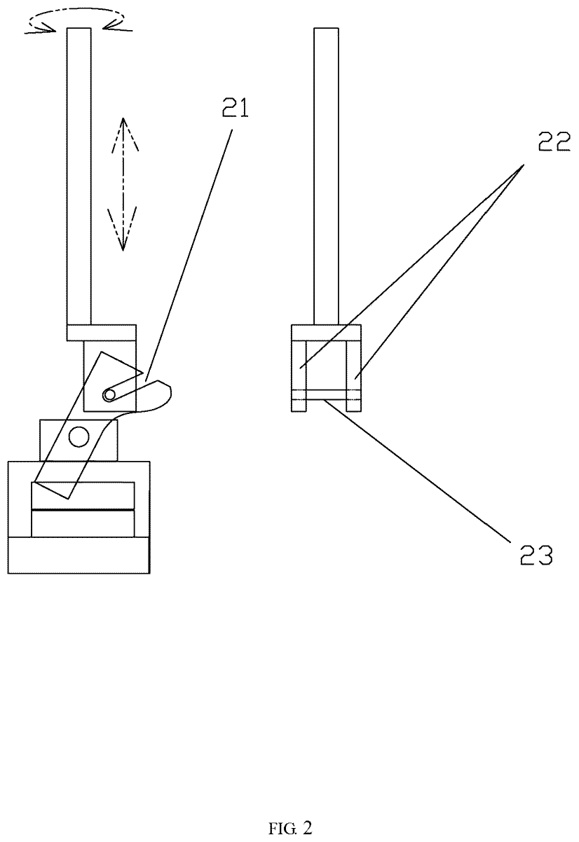

In FIG. 1 or 2, the hinge rod 23 should be in a horizontal pose and arranged parallel to the hinge groove 21, the inclined direction of the hinge groove needs to accord with the eccentric direction of the hinge pieces 22 and the hinge rod 23 which should be located on the same side of the valve shaft, so as to realize the design function and flexible operation. Said the hinge pieces, the hinge rod and the hinge groove configure a valve hinge (mechanism) to connect the valve stem with the valve core handle. Thereby, with which the vertical movement of pressing or lifting the valve shaft 11 will be converted into a deflexion rightwards of the valve core handle 12 of ceramic valve core around itself axis 15, and the horizontal rotation of the valve shaft around itself shaft axis will be transferred to valve core handle 12.

When the ceramic valve core 13 is in its closed position, as shown in FIG. 1, by pressing the centralized control button 14 to drive the valve shaft 11 vertically downwards, the hinge rod 23 tightened with the valve shaft will force the valve core handle to rotate clockwise around itself axis 15 via the hinge groove 21, finally dock at the opened position of the ceramic valve core 13; As shown in FIG. 2, when the valve stem moves vertically upwards (as can be known by background technology, after releasing the pressing on a button, the reset spring under the button will force the valve stem to move upwards), the hinge rod 23 will force the valve core handle to dock at its original vertical position, the closed position of the ceramic valve core, by pressing the button 14 repeatedly, the hinge so acts repeatedly to perform the switching operation of the ceramic valve core. For flow adjustable valve control devices, as the valve shaft can be docked at any position between the highest closed and lowest opened positions, the hinge rod 23 will force the ceramic valve core handle to dock at a position corresponding uniquely to that of the valve shaft, thereby the flow regulating is performed.

The flow adjustable valve control device in the background technology can force the valve shaft 11 to locate at any position of its vertical full journey, which correspond uniquely to an angle of deflexion rightwards of the valve core handle 12 forced to rotate, namely the opened extent, thus the flow regulation function of the ceramic valve core 13 can be realized.

When the valve shaft 11 is docked at any position of its vertical full journey, including the opened and closed positions, rotating the press-knob button 14 rightwards or leftwards, the hinge pieces 22 tightened to the valve shaft will rotate the valve core handle 12 leftwards or rightwards, thereby the selection of multiple water inlets can be realized.

The following hinge mechanism can substitute for said valve hinge (mechanism) configured by the hinge rod 23 and the hinge groove 21:

A wedge 61 tightened to the lower end of the valve stem 11 and to the upper left side of the hinge pieces 22 located on upper left side of the valve core handle 12, which inclined surface opposites to the upper left angle of the valve core handle 12, a recovery rod 62 tightened to the lower right side of the hinge pieces 22 is located under lower right of a curved surface of upper right part of the valve core handle 12, wherein, said inclined surface and curved surface are parallel to the axis of said recovery rod 62.

when the valve stem 11 moves vertically downwards, the inclined surface of the wedge 61 will drive the valve core handle 12 to rotate clockwise through its said upper left angle, and when the valve stem 11 moves vertically upwards, the recovery rod 62 will force the valve core handle 12 to rotate counterclockwise through its said curved surface then return to its initial closed position.

In this invention, only one button is mounted on top of a water valve, said centralized control button or press-knob button 14, which is integrated with all operations of switch and/or regulation of water flow of a single water inlet valve or all operations of switch and/or regulation of water flow and/or selection of inlets of a multiple water inlets valve, any switching of the work status of the centralized control valve all requires manual operation, full manually, facility for operation, saving for water, betterment for living quality, decoration for house.

Commonly, the single inlet water valve of ordinary skill switches water by rotating a knob on its top, or by pressing to open then close automatically. In this invention, it's a varied scene beyond imaged. A large angle oblique external thread accessory 33 tightened to the upper end of the single valve core handle 32 of a single inlet water valve is meshed with a large angle oblique internal thread accessory 34 tightened at the lower end of the valve stem 11, said two large angle oblique thread accessories meshed each other to configure a large angle oblique thread pair, a valve hinge mechanism to convert a straight line movement into a rotation movement; wherein by pressing or lifting the button 14, the vertically moving valve stem 11 will rotate the single valve core handle 32 to turn leftwards or rightwards via said large angle oblique thread pair to switch or regulate single supply water flow, therein said internal and external threads of the large angle oblique thread pair can be replaced mutually.

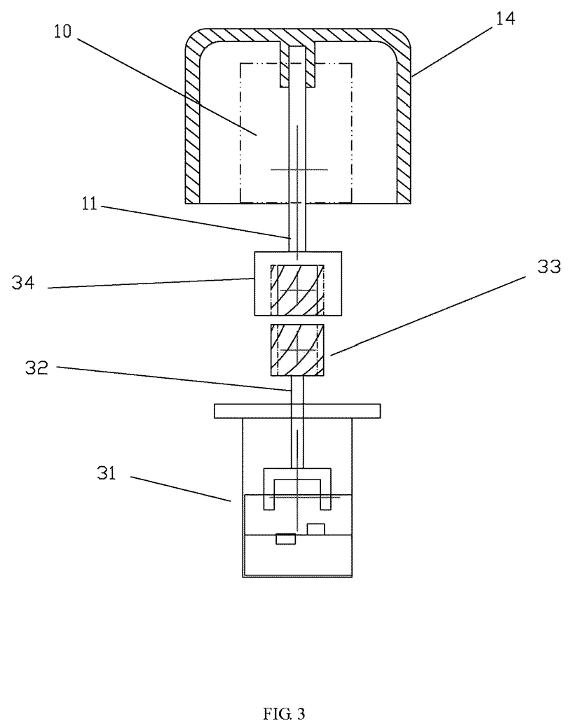

As shown in FIG. 3, what called the large-angle oblique thread pair indicates the angle between the internal or external thread line and a reference horizontal plane is much more large than usual, which may be more than 45°, when one of the thread is forced to move along itself axial direction, another meshed thread which can be rotated around itself axis but cannot be moved axially or radially will be flexibly rotated around itself axis without thread jam or self-locking.

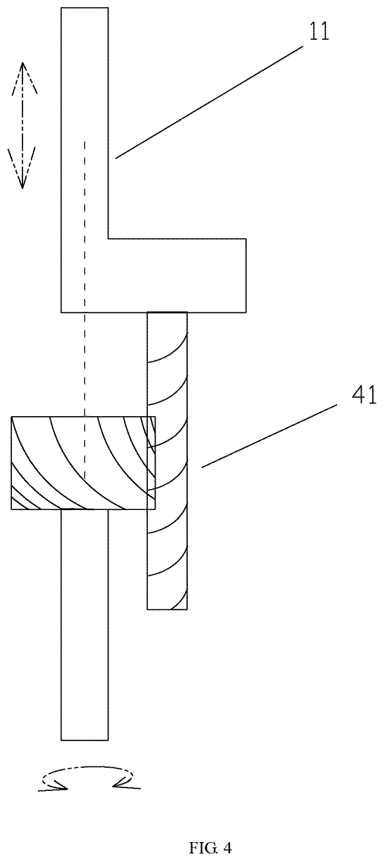

As shown in FIG. 4, a parallel shaft worm gear pair 41 can substitute for the large angle oblique thread pair said above and what their work principle is the same, one of worm gear/shaft accessory is tightened to the upper end of the single valve core handle 32 of a single inlet valve core and another worm gear/shaft accessory is tightened at the lower end of the valve shaft 11; furthermore

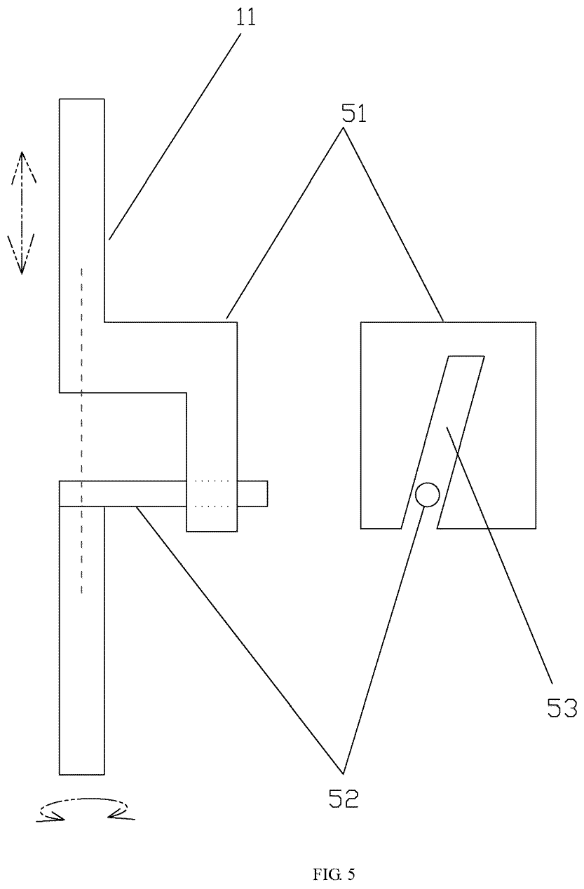

The large angle oblique thread pair can be replaced by an inclined groove fork 51 tightened at the lower end of a valve shaft 11 to drive a lever 52 tightened at the upper end of the single valve core handle 32 which configure an inclined fork lever hinge via an inclined groove 53 to realize said same conversion, as shown in FIG. 5, the vertical movement of the inclined groove fork 51 will rotate the lever 52 to a certain angle around its axis namely the valve core handle vertical axis by the inclined groove 53 to realize switch or regulation for supply water, wherein the inclination of the inclined groove 53 should be kept at an appropriate value to avoid to be blocked or no action, said inclination indicates the angle value configured by an extension direction of the inclined groove 53 with a reference vertical direction, which absolute value should be >0° and <90°.

### The Economic and Social Benefit

After the innovation and optimization of this application, the ordinary water valve has obtained new functions and more excellent performances, the centralized control valve, owns the natures of a simpler mechanism, a prompt operation, more safety and reliability, and a reduced failure rate. Thereby, while positively saving water, it facilitates civil daily life, improves work efficiency, increases life pastime, and stimulates the consciousness of responsibility and mission to society.

All our social activities from people must be to people, even if the theme of the new century is defined as resources, energy, people-oriented is still premise of it, separated from the concept of people, it looks pale and boring likely.

As what knew, we should not blame saving resources and energy, but blaming facility life for it looks pale and no significance. The centralized control valve makes people more willing and more convenient to save water, in view of the development of society, the continuous improvement of people's requirements for a quality of life, along with the continuous improvement of public morality awareness of civil society, convenience, saving resources and energy, must be organically integrated into production.

The invention can also be applied for other fluid feed control. The various mechanical structures described in this device can be applied to other civil equipment, furthermore, applied to industrial equipment, municipal establishment and equipment, military weapon and equipment, such as industrial valve, weapon fire control system, shot loading system, drive system etc.

### STATEMENT

Said above, others promised by law may draw out modifications and variations according to the structures and technology and principles of this invention, therefore that the appended claims are intended to cover such modifications and variations which are within the true scope and spirit of this invention.

What is claimed is:

1. A centralized control valve, comprising:
at least two eccentric hinge pieces 22 tightened at lower end of a valve shaft 11 which are tightened to a press-knob button 14, a centralized control button 14, as a whole;
said hinge pieces 22 clamped just outside of a valve core handle 12 which must be ensured that relative motion of the valve shaft 11 driving the valve core handle 12 is flexible;
a hinge rod 23 tightened to the lower part of said hinge pieces 22 and embedded in a penetrated hinge groove 21 with mouth opened right upwards on upper part of valve core handle 12 which must be ensured their relative motion of said hinge rod 23 driving said valve core handle 12 is flexible;
a valve hinge comprising the hinge rod 23, the hinge groove 21 and the hinge pieces 22 to drive the ceramic valve core 13;
when pressing the press-knob button 14 namely the valve shaft 11, the hinge rod 23 will rotate the valve core handle 12 clockwise around itself horizontal axis 15 by the hinge groove 21 and finally to dock at opened position of the ceramic valve core 13; otherwise
when the press-knob button moving upwards, the valve core handle 12 will be rotated counterclockwise around itself horizontal axis 15 and finally be docked at closed position of the ceramic valve core 13; furthermore
by controlling the valve shaft 11 to locate at any position including opened or closed position of itself whole vertical journey, the hinge rod 23 will force the valve core handle 12 to locate at a corresponding position to perform the function of water flow regulation; simultaneously
when the valve shaft 11 is located at any position said above, through the valve shaft 11 and the hinge pieces 22, a horizontal rotation of the press-knob button 14 will rotate the valve core handle 12 to perform the function of selecting multiple water inlets.

2. The centralized control valve according to claim 1, wherein the following hinge mechanism can substitute for said valve hinge configured by the hinge rod 23 and the hinge groove 21:
the lower end of the valve shaft 11 is tightened with a wedge 61 which inclined surface opposites to the upper left angle of the valve core handle 12, also tightened with a recovery rod 62 located under lower right of a curved surface of upper right part of the valve core handle 12;
wherein, said inclined surface and curved surface are parallel to the axis of said recovery rod 62;
when the valve shaft 11 moves vertically downwards, the inclined surface of the wedge 61 will drive the valve core handle 12 to rotate clockwise through said angle, and when the valve stem 11 moves vertically upwards, the recovery rod 62 will force the valve core handle 12 to rotate counterclockwise through said curved surface then return to its initial closed position.

3. A centralized control valve, characterized: only one press-knob button 14 mounted on top of water valve, to rotate said button to select an entering of multiple supply waters, to press said button repeatedly or moderately to switch or regulate a water flow.

4. A centralized control valve, comprising:
a large angle oblique external thread accessory 33 tightened at the upper end of a single valve core handle 32 for only one entering of supply water; and
a large angle oblique internal thread accessory 34 tightened at the lower end of a valve shaft 11; so said two large angle oblique thread accessories meshed each other to configure a large angle oblique thread pair;
wherein by pressing or lifting the press-knob button 14, the vertically moving valve shaft 11 will rotate the single valve core handle 32 to turn leftwards or rightwards via the large angle oblique thread pair to switch or regulate single supply water flow.

5. The centralized control valve according to claim 4, wherein a parallel shaft worm gear pair 41 can substitute for the large angle oblique thread pair to realize the conversion from vertical movement to horizontal rotation movement; or
a inclined groove fork 51 tightened at the lower end of a valve shaft 11 to drive a lever 52 tightened at the upper end of the single valve core handle 32 via an inclined groove 53 to realize said same conversion.
